(19) United States
(12) Patent Application Publication
(10) Pub. No.: US 2026/0321229 A1
(43) Pub. Date: Oct. 15, 2026

(54) Neck for a stringed musical instrument, integral carbon fiber composite structure, and neck mounting system.

(71) Applicant: Lynn Ray Mace, Kilgore, TX (US)

(72) Inventor: Lynn Ray Mace, Kilgore, TX (US)

(21) Appl. No.: 19/177,590

(22) Filed: Apr. 13, 2025

(51) Int. Cl. G10D 3/22; G10D 1/05; G10D 3/06

(52) U.S. Cl. CPC G10D 3/22; G10D 1/05; G10D 3/06

(57) ABSTRACT

A wood neck for a stringed musical instrument constructed using traditional methods, practices, and techniques of Lutherie. Having an integral carbon fiber composite structure that extends from the tip of the headstock, through the neck transition area, continually through the “D” shaped tapered shaft portion of the neck and into the distal heel end of the neck. Also having multiple carbon fiber bars asymmetrically located within the neck shaft at acute angles compensating for imbalanced string tension across the width of the neck, thereby focusing the stiffness node of the carbon fiber bars on the common point of the string tension convergence. Also having a neck mounting system of screw-mount nuts and the carbon fiber bars to form a unique integral clamping system. Thereby mitigating undesirable failure, breakage, warping, bowing, twisting, looseness and shifting of the neck of a stringed musical instrument, such as a guitar or bass.

### B) CROSS-REFERENCE TO RELATED APPLICATIONS

Provisional Application 63/647,110 (Dated 05/14/2024)

### C) STATEMENT REGARDING FEDERALLY SPONSORED RESEARCH OR DEVELOPMENT

NONE

### D) REFERENCE TO A “SEQUENCE LISTING” (IF APPLICABLE)

NOT APPLICABLE

### E) BACKGROUND OF THE INVENTION

### Field of the Invention

The present invention relates generally to stringed musical instruments. The present invention relates more particularly to the neck of a stringed musical instrument and comprises: an integral carbon fiber composite structure that extends from the tip of the headstock, thru the neck transition area, continually thru the “D” shaped tapered shaft portion of the neck and to the distal heel end of the fretboard and further comprises, a neck mounting system of screw-mount nuts and carbon fiber bars for mitigating undesirable failure, breakage, warping, bowing, twisting, looseness and shifting of the neck of a stringed musical instrument, such as a guitar or bass.

### Discussion of Prior Art

In prior art rods, shapes and bars manufactured from various materials have been installed within the back “D” shaped shaft portion of a wood neck, parallel to the neck centerline and underneath a partial length of the fretboard for the purpose of increasing the stiffness of the neck within the fretted area. In all forms of prior art examined, rods or bars have extended only a partial length of the fretboard or were limited to the length of the fretboard AND have been parallel to the longitudinal centerline of the neck.

As a preliminary note, it should be stated that there is a substantial amount of prior art that deals with stringed musical instruments, more particularly to the neck of a stringed musical instrument. This will be discussed in the following:
a. The Fishman, Parker patent (U.S. Pat. No.5,189,235) discloses a neck which has a layer of unidirectional carbon cloth on the back side of the neck.
b. The Rickard patent (U.S. Pat. No. 4,084,476) discloses a neck which is strengthened and stiffened by a trio of flat strips; however, they are placed within the neck in a triangular arrangement and of only the partial length of the fretboard.
c. The Smith, Blanda Patent (U.S. Pat. No. 6,888,055) discloses a support rod made from wood and wrapped in a composite material. However, the disclosure describes a support rod of only the partial length of the fretboard.
d. The Foltz patent (U.S. Pat. No. 7,786,361) discloses a wood on graphite layup instrument. However, the disclosure describes a tri-laminated neck made of 3 pieces of ¾″ thick wood and two runners of carbon graphite fabric.
e. The Mace patent (U.S. Pat. No. 6,774,292) discloses a graphite/carbon fiber and wood neck for stringed musical instruments. However, the disclosure describes a composite stressed skin type of structure.
f. The Lieber patent (U.S. Pat. No. 4,161,130) discloses a bowl-shaped body formed in a single piece of graphite, fiberglass, or impregnated fabric. However, the disclosure of the Lieber patent is directed only to the body, and not an entire instrument, including the neck being made of a plurality of layers of carbon fiber.
g. The Janes et al. patent (U.S. Pat. No. 5,333,527) discloses an improved guitar Soundboard that is made of a plurality of layers of epoxy impregnated graphite fibers. The content of the Janes patent is limited to the soundboard and does not include a corresponding neck of the instrument.
h. The Teel patent (U.S. Pat. No. 6,664,452) discloses an acoustic guitar constructed with a pre-finished graphite Soundboard and a pre-finished high-pressure laminate back board and sidewall. Again, the guitar of the Teel patent is limited to the soundboard and does not include a corresponding neck of the instrument.
i. The Kaman patent (U.S. Pat. No. 3,880,040) discloses a multiple ply soundboard for a guitar that is made of inner and outer plies of oriented graphite fiber material. Again, the disclosure is limited to a soundboard, and not a neck made of or with reinforced carbon fiber.
j. The Alfred, III patent (U.S. Pat. No. 7.276,868) discloses a carbon-fiber laminate musical instrument soundboard, which does not disclose a bridge reinforcement or neck made of or with reinforced carbon fiber.

While the above-described devices fulfill their respective and particular objects and requirements, they do not provide an integral carbon fiber composite structure that extends from the tip of the headstock, thru the neck transition area, continually thru the “D” shaped tapered shaft portion of the neck and to the distal heel end of the fretboard or a neck mounting system of screw-mount nuts and carbon fiber bars.

Prior art embodiments have NOT reinforced the headstock, and the transition area of the neck shaft into the headstock by the addition of an integral bonded composite structure made from a carbon fiber sheet and carbon fiber bars and,
Provided extended carbon fiber bars the full length of the fretboard AND substantially into the headstock and,
Asymmetrically located said carbon fiber bars within the neck to compensate for the imbalanced string tension and,
Located said carbon fiber bars at acute angles, said carbon fiber bars are aligned accordingly in the geometric shape of an acute trapezoid in order to provide maximum stiffness within the geometric shape the string tension field (this is Focused Tension-Field Geometry) and,
Integrated said carbon fiber bars into and within a neck mounting system of screw-mount nuts, thereby creating a clamping system of the carbon fiber bars, the wood of the neck and the screw-mount nuts and,
Utilized an expanding polyurethane adhesive to secure the truss rod within its machined channel to eliminate “truss rod rattle”.

Having conducted a comprehensive load and structural analysis using the measurements and calculations based on a progressive string spacing at the nut and having provided accurate data to reach the conclusion wherein, at the nut: 55% of the string tension load is imposed on and carried by the lower 45% of the neck and this is inversely true for the upper portion at the nut (45% of the string tension load is imposed on and carried by the upper 55%). This ratio holds true without significant variation regardless of string gage or scale length, as long as the instrument is tuned to the standard E, B, G, D, A, E tuning.

This condition is the reason for the carbon fiber bars being asymmetrically located within the “D” shaped, tapered shaft portion of the neck at acute angles to the longitudinal centerline of the neck.

Also, many guitar builders and manufacturers'efforts involving carbon fiber materials have been inadequately engineered and executed. For example, parallel graphite rods of insufficient length loosely placed in neck channels close to the center of the neck will only serve to create a limited node of stiffness about which the neck is likely to twist and warp. Also bowing at the end terminations of the graphite rods as this “blunt” termination within the stressed region of the neck shaft creates a stress riser point.

The tension field created by the strings is in the geometric form of an acute conical taper. This tension field converges at a point substantially past the nut and located below the centerline, therefore the carbon fiber bars are aligned and their respective stiffness nodes focused accordingly in the same geometric shape. The shape of an acute trapezoid. In order to provide maximum stability and stiffness, they must be congruent with the geometric shape of the string tension field (Focused Tension-Field Geometry).

The shape of the “string tension field” and the resulting asymmetrical load has been of a major importance in this design.

Furthermore, the carbon fiber bars must fit snugly and be completely constrained, bonded to and within the neck channels, as ANY torsional flexing of the carbon fiber bars due to looseness in the neck channels is hugely detrimental to the modulus of stiffness of the bars within the structure of the neck.

Another prior art method of improving the strength of the headstock, and the transition area of the neck shaft into the headstock has been the use of “Scarf joints” (also known as a Spanish Luthiers joint) which are structurally inadequate. In an effort to save materials and reduce costs, a neck blank of thinner material is sawn at an angle (typically 10-15 degrees), the cutoff is then flipped 180 degrees and glued.

This gluing of end grain to flat grain is an invitation to joint failure. Additionally, because of the grain structure now being reversed the internal stress of the wood is essentially doubled, temperature and humidity changes increase the stress on the glue joint.

This type of joint will also cause swelling, shrinkage, and movement of the fretboard in the area of the scarf joint (buzzing frets) and an ever changing “bump” in the back of the neck shaft. Eventually resulting in the failure of the fretboard bond line and the scarf joint itself. While this has been “A Solution” to the weak headstock it solves one problem and creates two more.

Previous embodiments of prior art have used truss rods of various designs, and materials, typically loosely placed in a machined channel within the “D” shaped tapered shaft portion of the neck, shims have been used to help constrain the truss rod however it is still prone to “rattle” and vibrate, creating what is known as “wolf tones”, a sitar like overtone that is caused by the vibration of two bodies that contact each other at an extremely shallow angle and excited by acoustical energy.

Such an angle is produced between the truss rod, fretboard, and the cavity when the truss rod is adjusted to counteract the bow of a neck. Bonding and fully encapsulating the truss rod in and with an expanding polyurethane adhesive mitigates this problem.

Previous embodiments of prior art have also used threaded screw-in inserts for the neck attachment (common to the furniture industry) in the heel of the neck, while this method reduces the possibility of the screws pulling out of the wood it increases the risk of splitting in the grain and it is not integrated with carbon fiber bars or any other form of neck reinforcement.

### BRIEF SUMMARY OF THE INVENTION

A wood neck for a stringed musical instrument constructed using contemporary or traditional methods, practices, and techniques of Lutherie.

Said wood neck having a headstock, a “D” shaped tapered shaft section, a heel for attachment to the instrument body, a fretboard, a nut, an adjustable truss rod, a plurality of strings and a plurality of holes for tuning machines.

Said neck shall also provide for “bolt on” type of installation to the instrument body.

Wood necks are frequently the subject of catastrophic failure at the headstock, primarily around the transition from the neck shaft to the tuners, at the scarf joint and from accidental breakage at the headstock area.

Wood necks are also affected by problems of warping, bowing, and twisting due to the imbalanced and asymmetrical string tension loads placed on the neck by the strings.

NOTE* A stringed musical instrument neck made from a yielding medium of wood, having a symmetric shape with an asymmetric load will require asymmetric rigidity. This invention provides exactly that solution.

Wood necks of the “bolt on” type of installation to the instrument body are subject to attachment failures, looseness, and “neck pocket shift” due to weakness in the physical attachment to the instrument body. In prior art these types of attachments have typically been nothing more than wood screws or inserts which fail by stripping out of the wood in the neck heel and/or splitting the wood heel at the attachment holes.

Wood necks having adjustable truss rods are prone to “truss rod rattle” and vibration, creating what is known as “wolf tones,” a sitar like overtone that is caused by the vibration of two bodies that contact each other at an extremely shallow angle and are excited by acoustical energy. Such an angle is produced between the truss rod, fretboard, and the cavity when the truss rod is tightened to counteract a bow of the neck.

This Invention addresses and corrects those problems described above by providing a comprehensive engineered integral carbon fiber composite structure that extends from the tip of the headstock, thru the transition area, continually thru the “D” shaped tapered shaft portion of the neck and to the distal heel end of the fretboard and also provides a neck mounting system for mitigating undesirable failure, breakage, warping, bowing, twisting, and shifting of the neck of a stringed musical instrument, such as a guitar or bass by:

Substantially reinforcing the headstock, and the transition area of the neck shaft to the headstock by the addition of an integral bonded carbon fiber composite structure made from a carbon fiber sheet and a plurality of carbon fiber bars. Said structure shall extend from the tip of the headstock, continually thru the “D” shaped tapered shaft portion of the neck and to the distal base of the fretboard, substantially reinforcing the area of the neck shaft to the headstock transition with scarf jointed carbon fiber bars and an integral carbon fiber sheet structure. This improves the resistance to accidental breakage, and catastrophic failure.

Also, said carbon fiber bars shall be asymmetrically located within the neck shaft at acute angles to compensate for the imbalanced string tension across the width of the neck. Focusing the stiffness of the carbon fiber bars on the common point of the string tension convergence. The carbon fiber bars shall be bonded within the neck, the headstock and to the carbon fiber sheet, also bonded to the fretboard. This improves the resistance to warping, bowing, and twisting due to the imbalanced string tension loads placed on the neck by the strings.

Also, an improved neck mounting system comprising a plurality of Screw-Mount Nut hardpoints that are integral with said carbon fiber bars to form a unique integral clamping system. This Improves the security, stability, and reliability of the neck attachment. Also improving the transfer of acoustical energy from the neck into the instrument body.

Also, a method of truss rod installation that eliminates “truss rod rattle” and vibration, known as “wolf tones.” This is accomplished by bonding and fully encapsulating the truss rod in and with an expanding high-density polyurethane foam adhesive.

### BRIEF DESCRIPTION OF THE DRAWINGS

FIG. 1 is a top view of the headstock (1) comprising: the “D” shaped tapered shaft mid-section (2), the Nut (8), the Nut mounting holes (9), Tuner holes (10), Carbon fiber bars (11) and a centerline reference (17). Illustrating the asymmetrical location of the carbon fiber bars at acute angles.

FIG. 2 is a side view of the headstock (1) and neck transition area comprising: the “D” shaped tapered shaft mid-section (2), the fretboard (4), the carbon fiber bars (11) and the structural carbon fiber sheet (12). Illustrating the embodiment of the invention applicable to a neck having a tilted or angled headstock design.

FIG. 3 is a side view of the headstock (1) and neck transition area comprising: the “D” shaped tapered shaft mid-section (2), the fretboard (4), the carbon fiber bars (11) and the structural carbon fiber sheet (12). Illustrating the embodiment of the invention applicable to a neck having a straight headstock design.

FIG. 4 is a cross-section view of the “D” shaped shaft mid-section (2) of the neck comprising: the fretboard (4), the adjustable truss rod (6) and the carbon fiber bars (11). Illustrating the asymmetrically located carbon fiber bars.

FIG. 5 is a cross-section view of the heel (3) portion of the neck comprising: the fretboard (4), the adjustable truss rod (6), the carbon fiber bars (11), and the screw-mount nuts (13) integral with the carbon fiber bars (11).

FIG. 6 is a top view of the heel (3) portion and “D” shaped tapered shaft mid-section (2) of the neck comprising: the truss rod channel (7), the carbon fiber bars (11) and the screw-mount nuts (13). Illustrating the asymmetrical location of the carbon fiber bars at acute angles and the screw mount nuts being integral with the carbon fiber bars.

FIG. 7 is a side view of the heel (3) portion of the neck comprising: the “D” shaped tapered shaft mid-section (2), the fretboard (4), the carbon fiber bars (11) the Screw-Mount Nut flanged top portion (14) and the Screw-Mount Nut internal threaded lower portion (16).

FIG. 8 is an isometric view of the screw-mount nuts (13) comprising: the carbon fiber bars (11), the Screw-Mount Nut flanged top portion (14), the Screw-Mount Nut slotted central portion (15), and Screw-Mount Nut internal threaded lower portion (16). Illustrating the integration of the carbon fiber bars into the screw-mount nuts.

FIG. 9 is a graph illustrating the progressive asymmetrical string spacing and the imbalanced string tension distribution across the width of the nut for a typical 7-string guitar.

FIG. 10 is a graph illustrating the formula, lines and points for determining the location and angles of the carbon fiber bars. (lines are extended and angles exaggerated to facilitate a better understanding of principles).

### DRAWING COMPONENT LEGEND

1) Headstock
2) “D” shaped tapered shaft mid-section
3) Heel
4) Fretboard
5) Metal frets
6) Adjustable truss rod
7) Truss rod channel
8) Nut
9) Nut mounting holes
10) Tuner holes
11) Carbon fiber bars
12) Structural carbon fiber sheet.
13) Screw-Mount Nuts
14) Screw-Mount Nut flanged top portion
15) Screw-Mount Nut slotted central portion
16) Screw-Mount Nut internal threaded lower portion
17) Centerline reference

### DETAILED DESCRIPTION OF THE INVENTION

A wood stringed musical instrument neck constructed using contemporary or traditional methods, practices, and techniques of Lutherie.

Said neck for a stringed musical instrument comprising: a wood instrument neck having a headstock (1), a “D” shaped tapered shaft portion (2), a heel end for attachment to an instrument body (3), a fretboard (4), a nut (8), an adjustable truss rod (6), a plurality of strings and a plurality of holes for tuners (10).

Said neck also having a mechanical form of machine screw attachment to an instrument body (13).

Said neck shall contain at least two carbon fiber bars (11) within the back “D” shaped tapered shaft portion (2), heel (3), and into the headstock (1) of the neck.

Wide necks may contain additional carbon fiber bars (11). An example of this configuration would be a 5-string Bass Instrument having 3 carbon fiber bars and two adjustable truss rods.

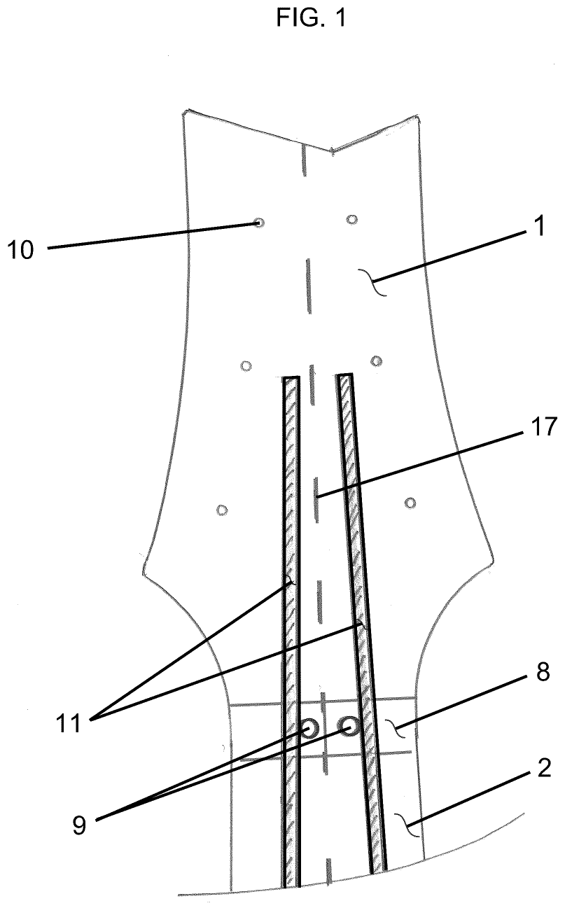

Said carbon fiber bars (11) shall extend the full length of the fretboard (4) AND past the nut (8) and into the headstock (1), (FIGS. 1, 2 and 3).

Said carbon fiber bars (11) shall be of a rectangular cross section (FIG. 8).

Machined channels shall be provided for the carbon fiber bars (11) within the wood neck and the headstock, said channels shall be a snug fit of the carbon fiber bars in both width and depth.

The carbon fiber bars (11) shall be asymmetrically located within the back “D” shaped tapered shaft portion (2) of the neck to compensate for an imbalance of the string tension fields about the longitudinal centerline (17) of the neck (FIGS. 1 and 6).

The asymmetrical location of the carbon fiber bars (11) shall be such that the carbon fiber bar's locations are congruent with the asymmetrical string spacing at the nut (8) and shall be equidistantly spaced at the distal heel end (3) of the neck (FIG. 6).

A neck providing for the installation of a locking nut (8) and requiring traverse nut mounting holes (9) at the nut shall have the asymmetrical location of the carbon fiber bars adjacent to the outermost tangent point of said nut mounting holes.

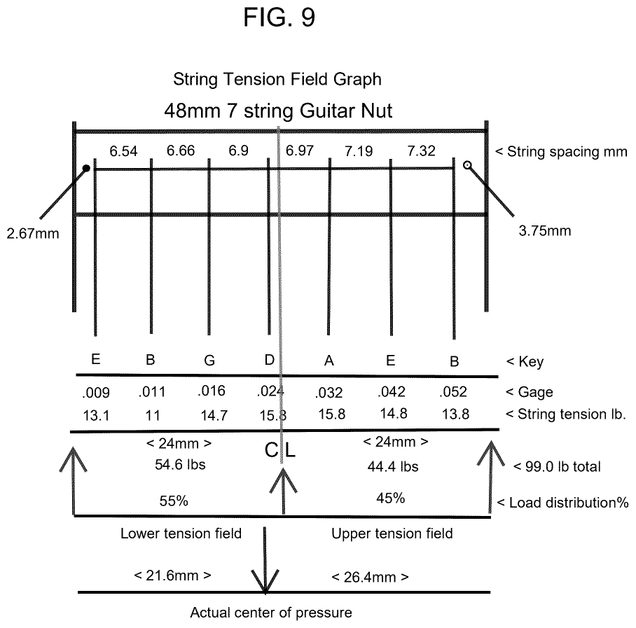

The carbon fiber bars (11) shall not be parallel to the longitudinal center line (17) of the neck but shall be aligned with the geometric shape of the string tension field of the neck respectively (As the sides of an acute trapezoid) (FIGS. 1, 6 and 9).

The structural integrity of the carbon fiber bars (11) between the tuner holes (10) and the distal end of the fretboard (4) shall not be compromised by drilling, screws, or machining. Cutting the ends to proper length, machining at the headstock (1) face to match the shape and form of the headstock, a light sanding of the surface to improve the adhesion of the epoxy laminating resin is all that is allowed.

The carbon fiber bars (11) shall be adhesively bonded with epoxy to and within the neck's “D” shaped tapered shaft section (2), heel (3), headstock (1).

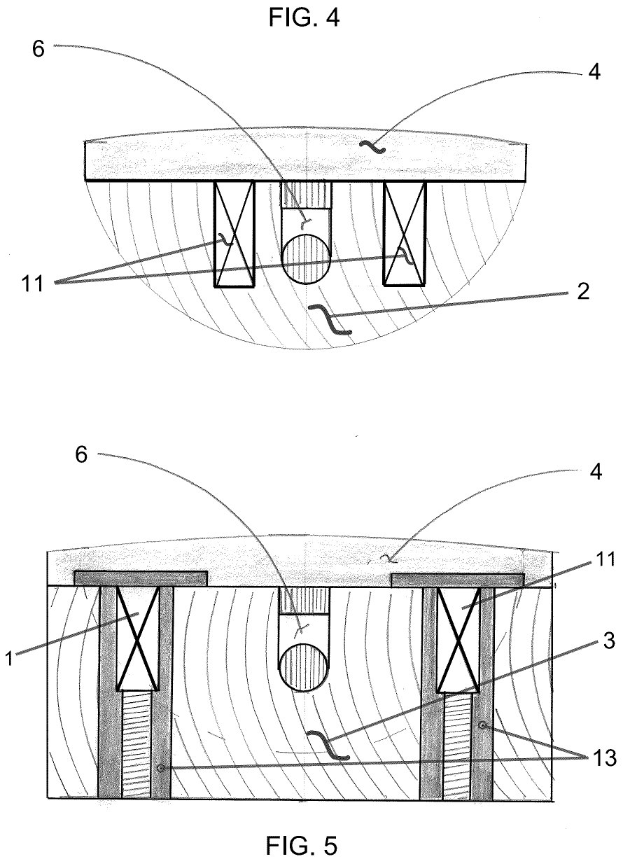

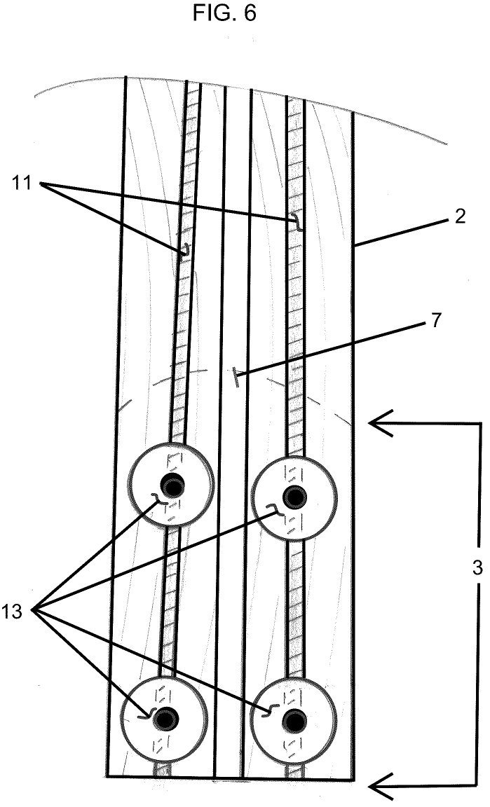

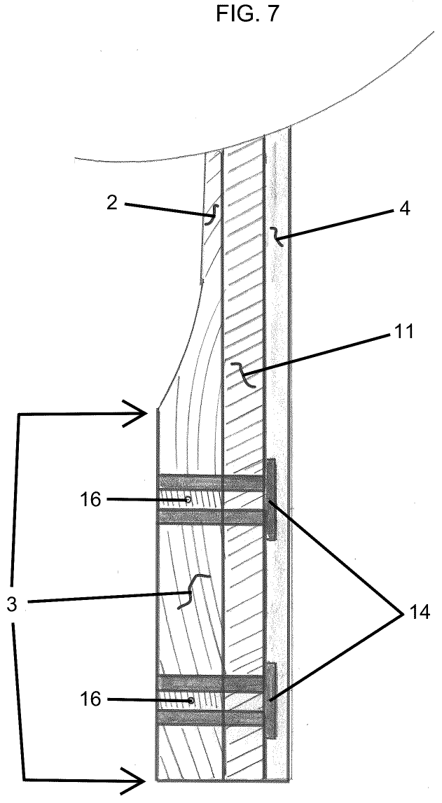

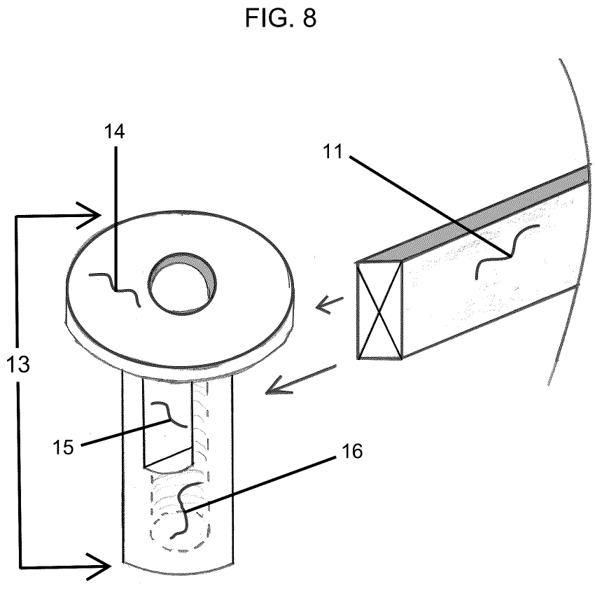

The carbon fiber bars (11) shall be even with the face of the “D” shaped tapered shaft portion (2) of the neck at the fretboard juncture and in physical contact with the bottom mating surface of the fretboard (4) (FIGS. 4 and 5).

The carbon fiber bars (11) shall be adhesively bonded to the fretboard (4) and the fretboard shall also be adhesively bonded to the “D” shaped tapered shaft portion (2) of the neck.

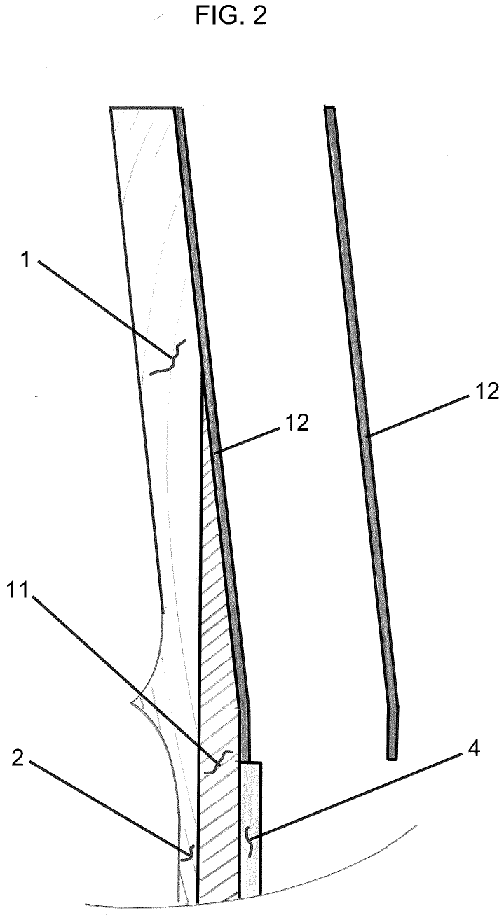

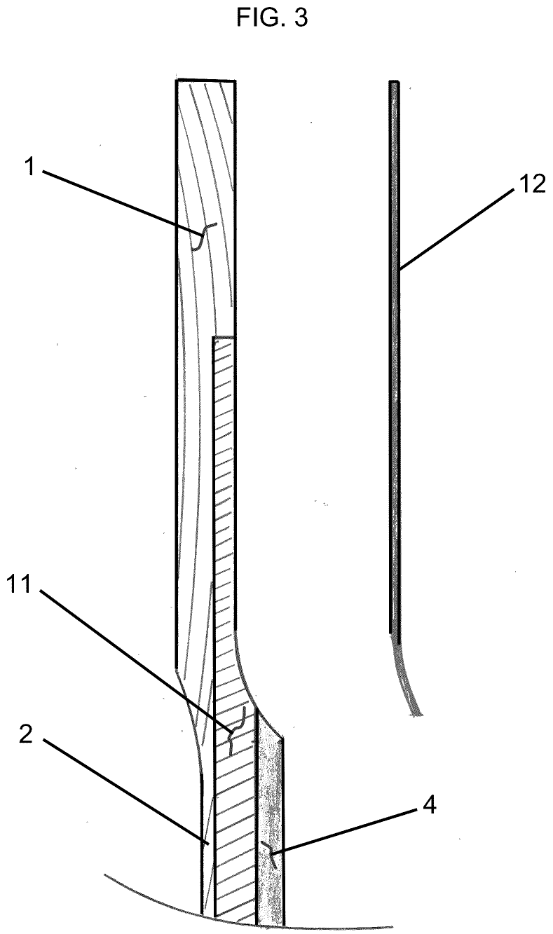

The carbon fiber bars (11) shall be machined at the headstock face to match the shape and form of the headstock (FIGS. 2 and 3) and to provide a joint for attachment of the structural carbon fiber sheet (12).

The carbon fiber bars (11) may be constructed with the corresponding angle, shape and form of the headstock and may extend completely from the tip of the headstock to the distal end of the fretboard. This may be done by manufacturing the carbon fiber bars to the desired angle, shape, and form or by an overlapping scarf joint assembly of additional carbon fiber bars being adhesively bonded together and forming a joint at the tangent point of the headstock.

The headstock (1) shall have a structural carbon fiber sheet (12) adhesively bonded with epoxy to the wood face of the headstock (1) and to the tapered scarf joint portion of the carbon fiber bars (11).

The structural carbon fiber sheet (12) bonded to the face of the headstock (1) shall be constructed from a plurality of Aerospace grade carbon fiber cloth and epoxy resin matrix.

In the preferred embodiment of the invention, structural carbon fiber sheet (12) should be made from 5 layers of carbon fiber, two outer layers of woven bidirectional cloth and one central layer of unidirectional carbon fiber and have a thickness of at least 0.040″.

A faux wood veneer may be added to the face of the headstock structural carbon fiber sheet (12) to retain a traditional wood appearance.

The improved neck mounting system comprising: a multi-point clamping apparatus shall consist of a plurality of Screw-Mount Nuts (13) installed in the neck heel (3), integrated with, attached to, and capturing the carbon fiber bars (11).

Said Screw-Mount Nuts (13) shall be constructed from steel, shall have an internal threaded lower portion (16), also having a central slotted upper portion (15) to accept the rectangular cross section of the carbon fiber bars (11) and having a flanged top portion (14) to bear against the carbon fiber bars and the wood of the neck at the heel (3).

Said carbon fiber bars (11) shall traverse the central slotted portion (15) of the Screw-Mount Nuts (13).

The Screw-Mount Nuts (13) having a flanged top (14) and that are located between the fretboard (4) and the heel portion of the neck (3), said flanged top shall bear against and be adhesively bonded to the traverse carbon fiber bars (11) to form an integral clamping structure so that the Screw-Mount Nuts (13) clamp against the carbon fiber bars (11) and the wood of the neck heel (3) when the neck is installed on the instrument body.

The adjustable truss rod assembly (6) shall be installed in a machined truss rod channel (7), adhesively bonded, and fully encapsulated with an expanding high-density polyurethane foam adhesive.

The fretboard (4) shall be counterbore machined to provide clearance for the flanged top portion (14) of the Screw-Mount Nuts (13).

The fretboard (4) shall be adhesively bonded to the “D” shaped tapered shaft portion (2) of the neck and heel (3) using traditional methods, practices, and techniques of Lutherie.

In the preferred embodiment of this invention wherein “Epoxy “resin is specified it shall be Gougeon Brothers West System 105/206 or the commercially available equivalent.

In the preferred embodiment of this invention wherein “Aerospace grade carbon fiber cloth” is specified it shall be AS-282 grade or the commercially available equivalent.

NOTE* A stringed musical instrument neck made from a yielding medium of wood, having a symmetric shape with an asymmetric load will require asymmetric rigidity. The following is the analysis and solution of this invention.

Focused Tension-Field Geometry:

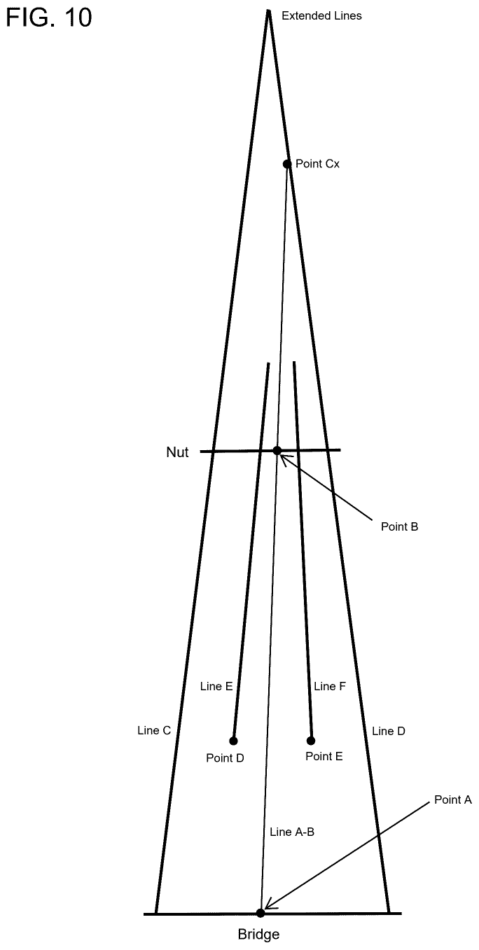

To calculate the location and angles of the carbon fiber bars within the neck the following procedure is required. See FIG. 10 graph, (lines are extended and angles exaggerated to facilitate a better understanding of principles).

Interpolation of two known datasets and extrapolation of a 3rd point of tension-field convergence.

Datums are established at the bridge and the nut. At the rear Bridge the datum is the outside face of the lower string saddle. At the Nut the datum is the lower outside face of the neck.

The formula is (F×D=M). Complete this calculation for each string individually at the bridge and at the nut. Sum the force and the moments separately for each location. Total moments/total F=CP (F=force of the individual string tension), D=distance from the relative Datum, M=moment, W=total width of the string spread, (CP=resultant center of pressure from the Datum). This formula will remain constant regardless of the number of strings.

The first datapoint is solved by calculating the center of pressure (CP) at the bridge (Point A).

The second datapoint is solved by calculating the center of pressure (CP) at the nut (Point B).

A Line is drawn from point A through point B and extended. This is the center of pressure of the tension-field (line A-B).

Lines C and D are the acute triangle sides representing the outermost strings.

The first interpolation is the point of convergence of the string tension field beyond the nut. It is graphed by the intersection of line A-B, and Line D (Point Cx).

Line A-B is the center of pressure of the string tension-field and Point Cx is the true geometric focal point of the tension-field.

The Extrapolation of the convergence of lines E and F, which represent the carbon fiber bars from the fixed points of the neck mounting hardpoints (Points D and E) to the answer of CP is a resultant acute scalene triangle and the asymmetrical angles of the carbon fiber bars and their locations within the neck.

The lines of convergence of the carbon fiber bars (lines E and F) must intersect Line A-B within Lines C and D.

Dimensions and tensions will vary depending on the design of the instrument, number of strings, string gage, tunings and scale length. The formula and procedure will remain constant.

The acute angle of line A-B is a result of three factors: 1) Wide symmetrical string spacing at the bridge with the CP above the centerline, 2) Narrow asymmetrical (progressive) string spacing at the nut with the CP below the centerline and, 3) The taper ratio of the neck. This acute angle will vary depending on the location of points D and E.

An example of the typical deviation of line A-B for a six-string guitar with 10-46 strings and standard tuning is 0.221″ between the bridge and the nut.

1. A neck for a stringed musical instrument comprising: a wood instrument neck having a headstock, a “D” shaped tapered shaft portion, a heel end for attachment to an instrument body, a fretboard, a nut, a truss rod, a plurality of strings and a plurality of holes for tuners: further comprising an integral bonded composite structure that is comprised of a plurality of carbon fiber bars and a carbon fiber sheet, wherein said carbon fiber bars shall be adhesively bonded within said “D” shaped tapered shaft portion and extend the full length of said fretboard and into said headstock, wherein said carbon fiber sheet shall be adhesively bonded to said headstock and to the carbon fiber bars, wherein said integral bonded composite structure shall extend from the tip of the headstock, continually thru the “D” shaped tapered shaft portion of said neck and to the distal said heel end of said fretboard.

2. A neck for a stringed musical instrument as in claim 1 wherein said carbon fiber bars are made from a suitable size and length of a carbon fiber pultrusion having a rectangular cross-sectional shape.

3. A neck for a stringed musical instrument as in claim 1 wherein said carbon fiber sheet is made from a plurality of layers of carbon fiber cloth in an epoxy resin matrix on a mold using pressure.

4. A neck for a stringed musical instrument as in claim 1 wherein said headstock, said “D” shaped tapered shaft portion and said heel end shall have a plurality of machined channels provided for the installation of said carbon fiber bars.

5. A neck for a stringed musical instrument as in claim 4 wherein said headstock, said “D” shaped tapered shaft portion and said heel end shall have a plurality of machined channels wherein said machined channels shall be provided at acute angles to the longitudinal center line of said neck.

6. A neck for a stringed musical instrument as in claim 4 wherein said carbon fiber bars having a rectangular cross-sectional shape shall be adhesively secured to and within said headstock, said “D” shaped tapered shaft portion and said heel end in said plurality of machined channels using an epoxy laminating resin.

7. A neck for a stringed musical instrument as in claim 6 wherein said carbon fiber bars shall be machined at said headstock to a corresponding form of the headstock and flush with the face of the headstock to provide a joint for attaching and adhesively securing.

8. A neck for a stringed musical instrument as in claim 1 wherein said carbon fiber bars shall be adhesively bonded to said fretboard and the fretboard shall also be adhesively bonded to said “D” shaped tapered shaft portion of said neck and said heel end.

9. A neck for a stringed musical instrument as in claim 3 wherein said carbon fiber sheet is adhesively secured to said headstock and said carbon fiber bars with an epoxy laminating resin.

10. A neck for a stringed musical instrument comprising: a wood instrument neck having a headstock, a “D” shaped tapered shaft portion, a heel end for attachment to an instrument body, a fretboard, a nut, a truss rod, a plurality of strings and a plurality of holes for tuners: further comprising a plurality of carbon fiber bars having a rectangular cross-sectional shape wherein said carbon fiber bars shall be asymmetrically located within said “D” shaped tapered shaft portion of said neck at acute angles to the longitudinal centerline of the neck.

11. A neck for a stringed musical instrument as in claim 10 wherein said carbon fiber bars shall be located within said “D” shaped tapered shaft portion of said neck at acute angles wherein said acute angles shall be equal to or greater than the taper angle of the “D” shaped tapered shaft portion of the neck.

12. A neck for a stringed musical instrument as in claim 10 wherein said nut has an asymmetrical progressive spacing for said plurality of strings wherein said carbon fiber bars shall be asymmetrically located within said “D” shaped tapered shaft portion of said neck wherein the asymmetrical location of said carbon fiber bars shall be such that the carbon fiber bars locations shall be congruent with said asymmetrical progressive spacing of said nut.

13. A neck for a stringed musical instrument as in claim 10 wherein said carbon fiber bars shall be equidistantly spaced at said heel end of said neck.

14. A neck for a stringed musical instrument comprising: a wood instrument neck having a headstock, a “D” shaped tapered shaft portion, a heel end for attachment to an instrument body, a fretboard, a nut, a truss rod, a plurality of strings and a plurality of holes for tuners further comprising: a plurality of carbon fiber bars and a plurality of screw-mount nuts for attaching said neck to a body, wherein said carbon fiber bars having a rectangular cross sectional shape shall traverse said screw-mount nuts to form an integral clamping apparatus.

15. A neck for a stringed musical instrument as in claim 14 wherein said screw-mount nuts shall be constructed from steel and shall have an internal threaded lower portion, also having a slotted central portion to accept the traversed rectangular cross-sectional shape of said carbon fiber bars and having a flanged top portion to bear against said traverse carbon fiber bars and said wood neck.

16. A neck for a stringed musical instrument as in claim 14 wherein said screw-mount nuts are located between the fretboard and the heel portion of said neck and shall bear against and be adhesively bonded to said carbon fiber bars to form an integral clamping apparatus wherein said screw-mount nuts and a plurality of screws shall clamp against the carbon fiber bars and said wood neck.

17. A neck for a stringed musical instrument as in claim 1 wherein said truss rod shall be installed in a machined channel, adhesively bonded, and fully encapsulated with an expanding high-density polyurethane foam adhesive.
